(19) United States
(12) Patent Application Publication
(10) Pub. No.: US 2007/0059498 A1
(43) Pub. Date: Mar. 15, 2007

(54) Methods and apparatus for decorative sheeting for an appliance

(76) Inventors: Jan Anderson, Yellow Springs, OH (US); Jason Augenstein, Enon, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/473,603

(22) Filed: Jun. 23, 2006

Related U.S. Application Data
(60) Provisional application No. 60/693,713, filed on Jun. 24, 2005.

(51) Int. Cl. B41M 5/00; B05D 1/32; B05C 13/00

(52) U.S. Cl. 428/195.1; 427/282; 118/500

(57) ABSTRACT

A plurality of decorative sheeting for changing the appearance of an appliance that includes a first main sheet having a first dimension, a second dimension, and a first surface having a decorative pattern and a first filler sheet having a first dimension, a second dimension, a first surface having a filler sheet decorative pattern that corresponds to the decorative pattern of the first main sheet. The first dimension of the first filler sheet is substantially equal to the first dimension of the first main sheet, and the second dimension of the first filler sheet is an order of magnitude less than the second dimension of the first main sheet. The first main sheet is configured to cover a portion of a first external surface located on a first side of an appliance, and the first filler sheet is configured to cover a portion of the first external surface, adjacent to the first main sheet.

### CROSS REFERENCE TO RELATED APPLICATIONS

This application claims the benefit of U.S. Provisional Application No. 60/693,713 filed Jun. 24, 2005.

### FIELD OF THE INVENTION

The present invention relates generally to methods and apparatus for changing the appearance of an appliance. The apparatus and methods provide decorative sheets having a decorative pattern on one side thereof for application onto an external surface of one or more appliances.

### BACKGROUND OF THE INVENTION

After an appliance has been used for many years, it can have an appearance that is worn or that simply does not aesthetically fit the area in which the appliance is located. For example, kitchen areas are often remodeled, and the appliances in the remodeled kitchen may not match the decorative decor of the kitchen. This forces the owner of the kitchen to purchase all new appliances if he wants the appliances to match the decor, even though the appliances being replaced may be in good working order.

In the past, techniques were used to change the appearance of the appliance. For example, a user would sometimes paint the appliance, which necessitated applying a coat of paint directly to the appliance. This approach had various drawbacks, including its inability to cover up deep nicks, scratches and dents in the surface of the appliance. Another drawback with the painting techniques of the past is that the paint applied to the appliance was permanent. Another drawback of the past was that a decorative pattern, such as a floral pattern, picture of a favorite scene, or other artistic impression could not easily be applied to the appliance without significant expense.

What is needed, therefore, is a simple and nonpermanent system and method for changing the decorative appearance of an appliance.

### SUMMARY OF THE INVENTION

The present invention is directed to a plurality of decorative sheeting for changing the appearance of an appliance.

One embodiment of the present invention is a plurality of decorative sheeting for changing the appearance of an appliance that includes a first main sheet having a first dimension, a second dimension, and a first surface having a decorative pattern and a first filler sheet having a first dimension, a second dimension, a first surface having a filler sheet decorative pattern that corresponds to the decorative pattern of the first main sheet. The first dimension of the first filler sheet is substantially equal to the first dimension of the first main sheet. Also, the second dimension of the first filler sheet is an order of magnitude less than the second dimension of the first main sheet. The first main sheet is configured to cover a portion of a first external surface located on a first side of an appliance and the first filler sheet is configured to cover a portion of the first external surface, adjacent to the first main sheet.

Another embodiment of the present invention is a system for changing the appearance of an appliance having an original appearance that includes first and second main sheets for covering a portion of respective first and second external surfaces located on a first side of an appliance, each of the first and second main sheets having a first dimension, a second dimension, a first surface having a decorative pattern and at least one filler sheet for covering a portion of at least one of first and second external surfaces, the at least on filler sheet having a first dimension, a second dimension, a first surface having a filler sheet decorative pattern that corresponds to the decorative pattern of at least one of the first and second main sheets. The first dimension of the at least one filler sheet is substantially equal to the first dimension of at least one of the first and second main sheets. In addition, the second dimension of the at least one filler sheet is an order of magnitude less than the second dimension of at least one of the first and second main sheets.

Yet another embodiment of the present invention is a method for changing the appearance of an appliance having an original appearance. The method includes providing a first main sheet for covering a portion of a first external surface located on a first side of an appliance, wherein the first main sheet includes a first dimension, a second dimension, a first surface having a decorative pattern, and a second surface for attaching to the first external surface; providing a first filler sheet for substantially covering any remaining portion of the first external surface not covered by the first main sheet, wherein the first filler sheet having a first dimension, a second dimension, a first surface of the filler sheet having a filler sheet decorative pattern that corresponds to the decorative pattern of the first main sheet, and a second surface of the filler sheet for attaching to the first external surface; making the first dimension of the first filler sheet to be substantially equal to the first dimension of the first main sheet; and making the second dimension of the first filler sheet to be an order of magnitude less than the second dimension of the first main sheet.

### BRIEF DESCRIPTION OF THE SEVERAL VIEWS OF THE DRAWINGS

The following detailed description of exemplary embodiments of the present invention can be best understood when read in conjunction with the following drawings, where like structure is indicated with like reference numerals and in which:

FIG. 1 is a front plan view of an exemplary embodiment of a plurality of decorative sheets applied to an appliance according to the present invention;

FIG. 2 is a cross sectional view of the decorative sheet illustrated in FIG. 1;

FIG. 3 is a front plan view of an exemplary embodiment of a plurality of decorative sheets applied to an appliance according to the present invention;

FIG. 4 is a front plan view of an exemplary embodiment of a plurality of decorative sheets applied to an appliance according to the present invention;

FIG. 5 is a front plan view of an exemplary embodiment of a plurality of decorative sheets applied to an appliance according to the present invention; and

FIG. 6 is a perspective view of an exemplary embodiment of a plurality of decorative sheets applied to multiple appliances according to the present invention.

### DETAILED DESCRIPTION

In the following detailed description of the exemplary embodiments, reference is made to the accompanying drawings that form a part hereof, and in which is shown by way of illustration, and not by way of limitation, specific exemplary embodiments in which the invention may be practiced. It is to be understood that other embodiments may be utilized and that logical, mechanical and electrical changes may be made without departing from the spirit and scope of the present invention.

The present invention comprises at least one main decorative sheet having a decorative pattern on one of its surfaces for covering a portion of an external surface of an appliance (e.g., a refrigerator door) and at least one filler sheet for covering at least a portion of any remaining external surface exposed (not covered) by the main decorative sheet. The filler sheets, as used herein, are configured to cover a portion, a substantial portion, majority, and/or most of any remaining external surface located on the same side of the appliance as the main sheet that is left exposed or not covered by the main sheet. It has been found that one or more main sheets may be pre-fabricated with a predetermined size such that it may cover a portion, a substantial portion, majority, and/or most of an external surface of most similar-type appliances without requiring the customer to call in the make and model number of the appliance in order for a manufacturer to custom cut the decorative sheets to the appropriate size to fit the customer's specific appliance or without requiring the customer to measure and/or cut the decorative sheets to the appropriate size himself/herself. Similar-type appliances, as used herein, is defined as appliances of the same general design, for example, all side-by-side refrigerators would be of the same general design, all top-freezers would be of the same general design, etc.

It also has been found that one or more filler sheets may be pre-fabricated in a pre-determined size for similar-type appliances to fill in or cover at least a portion of the external surface left exposed by the main sheet due to size differences in the similar-type appliances (e.g., different sizes in doors between two different models of side-by-side refrigerators) and/or locations of accessories (e.g., the location of ice/water dispenser of similar-type refrigerators). The present invention permits a manufacturer to pre-fabricate the decorative main sheets and decorative filler sheets and keep an inventory prior to customers ordering or purchasing the decorative sheets. The present invention may be used with all types of appliances, including but not limited to refrigerators such as side-by-side door refrigerators, top-freezer refrigerators, and bottom-freezer refrigerators, freezers such as side-kick freezers, upright freezers, and chest freezers, washers and dryers such as top and bottom load, dishwashers, trash compactors, and any other appliances known to one of ordinary skill in the art.

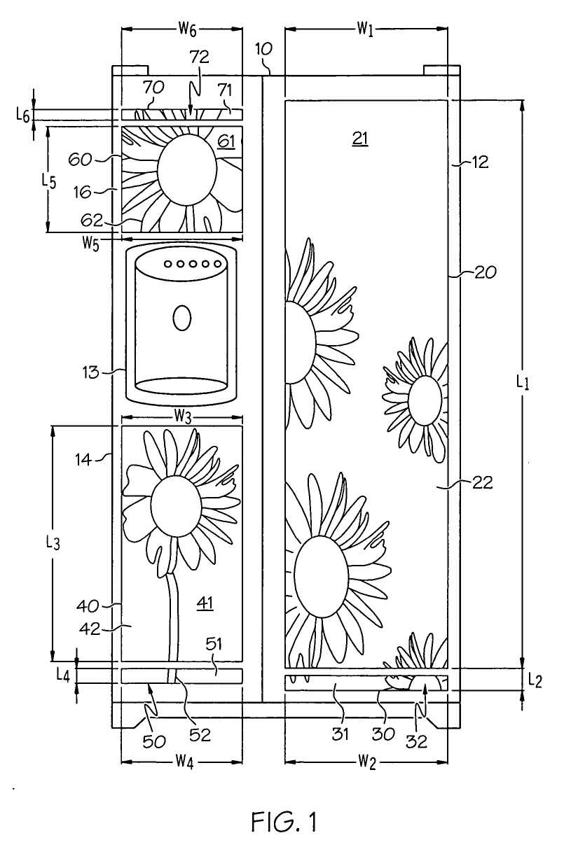

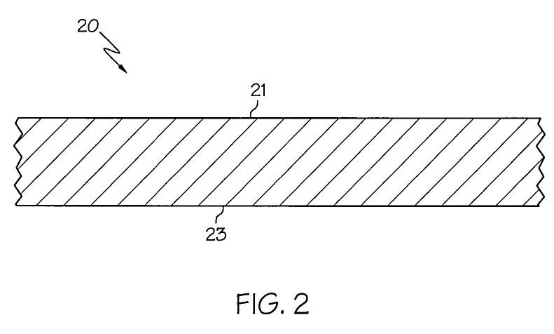

Referring to FIG. 1, an exemplary embodiment of the present invention is shown as including a first main sheet 20 for covering a portion of a front external surface of a right door 12 of most side-by-side refrigerators (e.g., side-by-side refrigerator 10), a second main sheet 40 for covering a portion of a front external surface of a lower portion 14 of a left door 13 of most side-by-side refrigerators (e.g., refrigerator 10), and a third main sheet 60 for covering a portion of a front external surface of an upper portion 16 of left door 13. Although not required, in the exemplary embodiment, first main sheet 20 is sized to cover a substantial portion or most of the front external surface of right door 12, and second and third main sheets 40 and 60 are sized to cover a substantial portion or most of the front external surfaces of lower portion 14 and upper portion 16 of left door 13, respectfully. In the exemplary embodiment shown in FIG. 1, main sheet 20 is configured to cover at least 51% of the surface area of door 12. Also, main sheet 40 is configured to cover at least 51% of the surface area of lower portion 14 of door 13. Main sheet 60 is configured to cover at least 51% of the surface area of upper portion 16 of door 13. In another exemplary embodiment, each of main sheets 20 and 40 and 60 is configured to cover at least 75% of the surface area of each of doors 12 and 13, respectively. In still another exemplary embodiment, each of main sheets 20 and 40 and 60 is configured to cover at least 90% of the surface area of each of doors 12 and 13, respectively. First main sheet 20 may include length dimension (L₁), a width dimension (W₁), a front surface or side 21 having a decorative pattern 22, and a back surface or side 23 (FIG. 2). Second main sheet 40 may include length dimension (L₃), a width dimension (W₃), a front surface or side 41 having a decorative pattern 42, and a back surface or side (not shown but may be similar to and/or the same as back surface 23 of first main sheet 20). Third main sheet 60 may include length dimension (L₅), a width dimension (W₅), a front surface or side 61 having a decorative pattern 62, and a back surface or side (not shown but may be similar to and/or the same as back surface 23).

As set forth above, first, second, and third main sheets 20, 40, and 60, respectively, include a back surface (e.g., back surface 23). Such a back surface may be configured to attach, adhere, connect, and/or apply the main sheets to any external surface of doors 12 and 13. For example, back surface 23 may define a magnetic sheet or surface that removably attaches main sheet 20 to the front external surface of right door 12 of refrigerator 10, the back surface of second main sheet 40 may define a magnetic sheet or surface that removably attaches main sheet 40 to the front external surface of lower portion 14 of left door 13, and the back surface of third main sheet 60 may define a magnetic sheet or surface that removably attaches main sheet 40 to the front external surface of upper portion 16 of left door 13. In another exemplary embodiment, the back surfaces of first, second, and third main sheets 20, 40, and 60 may each comprise an adhesive layer or sheet (e.g., pressure sensitive adhesive) that attaches the main sheets to door 12 and/or lower portion 14 and upper portion 16 of door 13. It is understood that the back surface (e.g., first back surface 23, FIG. 2) may comprise a variety of other technologies and methods to attach, adhere, connect, or apply first, second, and third main sheets 20, 40, and 60 to external surfaces of refrigerator 10 such as doors 12 and 13 as known to one of ordinary skill.

Decorative pattern 22 of first main sheet 20, in this exemplary embodiment, comprises a picture of a plurality of sunflower plants. Decorative pattern 42 of second main sheet 40 comprises a close-up picture of a sunflower plant (e.g., the flower and its stem), while decorative pattern 62 of third main sheet 60 comprises a close-up of just the flower portion of a sunflower plant. In the exemplary embodiment, decorative patterns 22, 42, and 62 substantially correspond to each other. Corresponds, as used herein, is defined as being of a similar and/or common decorative pattern, theme, image, picture, color(s), and/or concept. In the exemplary embodiment shown in FIG. 1, all three decorative patterns (e.g., 22, 42, 62) of the three main sheets have a common sunflower theme and thus correspond to each other. As shown, decorative patterns 22, 42, and 62 are not extensions of each other's decorative pattern or image. In other words, each decorative pattern is a separate and distinct image and/or picture on its own, but each has an image or picture that matches the common decorative pattern or theme (sunflower) of the other decorative patterns.

As set forth above, the present invention may include at least one filler sheet designed to cover a portion, substantial portion, majority, and/or most of any remaining portion of the front external surface that is left exposed or uncovered by the main sheet. The exemplary embodiment shown in FIG. 1 includes a first filler sheet 30, a second filler sheet 50, and a third filler sheet 70. First filler sheet 30 is configured or pre-fabricated to cover a substantial portion of the right door (e.g., right door 12) of most side-by-side refrigerators (e.g., refrigerator 10) that is left exposed or uncovered by first main sheet 20. Second filler sheet 50 is configured or pre-fabricated to cover a substantial portion of a lower portion (e.g., lower portion 14) (e.g., refrigerator 10 of the left door of most side-by-side refrigerators) that is left exposed or uncovered by second main sheet 40. Third filler sheet 70 is configured to cover a substantial portion of an upper portion of the left door (e.g., upper portion 16) of most side-by-side refrigerators (e.g., refrigerator 10) that is left exposed or uncovered by third main sheet 60. First, second and third (30, 50, 70 filler sheets) may be configured to cover at least 51% of the surface area of doors 112 and 113 left exposed by first, second and third main sheets (20, 40, 60), respectively. First, second and third (30, 50, 70 filler sheets) may be configured to cover at least 75% of the surface area of doors 112 and 113 left exposed by first, second and third main sheets (20, 40, 60), respectively. First, second and third (30, 50, 70 filler sheets) may be configured to cover at least 90% of the surface area of doors 112 and 113 left exposed by first, second and third main sheets (20, 40, 60), respectively.

First filler sheet 30 may include length dimension (L₂), a width dimension (W₂), a front surface or side 31 having a decorative pattern 32, and a back surface or side (not shown but may be similar to and/or the same as back surface 23 of first main sheet 20). Second filler sheet 50 may include length dimension (L₄), a width dimension (W₄), a front surface or side 51 having a decorative pattern 52, and a back surface or side (not shown but may be similar to and/or the same as back surface 23 of first main sheet 20). Third main sheet 70 may include length dimension (L₆), a width dimension (W₆), a front surface or side 71 having a decorative pattern 72, and a back surface or side (not shown but may be similar to and/or the same as back surface 23 of first main sheet 20). Width dimension (W₂) of first filler sheet 30 is substantially equal to width dimension (W₁) of first main sheet 20, and length dimension (L₂) is at least an order of magnitude less than length dimension (L₁) of main sheet 20. Also, width dimension (W₄) of second filler sheet 50 is substantially equal to width dimension (W₃) of second main sheet 40, and length dimension (L₄) is at least an order of magnitude less than length dimension (L₃) of the second main sheet. Finally, width dimension (W₆) of third filler sheet 70 is substantially equal to width dimension (W₅) of third main sheet 60, and length dimension (L₆) is at least an order of magnitude less than length dimension (L₅) of the third main sheet.

The back surfaces or sides of each of the respective first, second, third filler sheets 30, 50, and 70 may be configured to attach, adhere, connect, or apply the filler sheets to any external surface of an appliance. For example, the filler sheet back surfaces may define a magnetic sheet or surface that removably attaches the respective filler sheets 30, 50, 70 to the front external surface of right door 12, lower portion 14 of left door 13, and upper portion 16 of left door 13, respectively. Similar to the main sheets, each filler sheet back surface may also comprise an adhesive layer or sheet (e.g., pressure sensitive adhesive) that attaches the respective filler sheets 30, 50, and 70 to the front external surface of door 12, lower portion 14, and upper portion 16, respectively. It is understood that the back surfaces may comprise a variety of other technologies and methods to attach, adhere, connect, or apply the filler sheets to doors 12 and 13 of refrigerator 10 as known to one of ordinary skill.

In the present invention, first filler sheet 30 may include decorative pattern 32 that corresponds to decorative pattern 22, second filler sheet 50 may include decorative pattern 52 that corresponds to decorative pattern 42, and third filler sheet 70 may include decorative pattern 72 that corresponds to decorative pattern 62. With the main sheet decorative patterns corresponding with each other and with their respective filler sheet decorative patterns, the decorative sheets (main and filler) of the present invention create one common decorative pattern, theme, or image displayed across an external surface of the appliance (e.g., the front external surface of a refrigerator). As shown in FIG. 1, the exemplary embodiment includes first, second, and third filler sheet decorative patterns 32, 52, and 72 that, not only correspond to, but are extensions of the sunflower images of the respective main sheet decorative patterns 22, 42, and 62. Extension, as used herein, is defined as an image in a second decorative pattern that is a furtherance of, a partial completion of, and/or a full completion of an image in a first decorative pattern. For example, decorative pattern 72 (i.e., the sunflower petals) is an extension of the sunflower of decorative pattern 62 because decorative pattern 72 extends or partially completes the image of the petals in decorative pattern 62. Although not required by the invention, the decorative pattern of the main sheets can also be extensions of each other to create one continuous image or picture across the front external surfaces of all the doors.

Each of the first, second, and third main sheets and each of the first, second, and third filler sheets may be a single layer sheet or a multilayer laminate or substrate as known to one of ordinary skill in the art. It is also understood that the first surface of these sheets (e.g., 21, 31, 41, 51, 61, and 71) may comprise a variety of conventional material as known to one of ordinary skill in the art, including but not limited to plastics, polymers, elastomers, vinyl, metal (e.g., stainless), wood, composites, or other like materials. The main and filler decorative sheets of the present invention may comprise the decorative sheets shown and described in U.S. Pat. No. 6,840,773 to Anderson et al. and herein incorporated by reference in its entirety.

The decorative patterns of the main sheets and filler sheets of the present invention, including but not limited to those shown in FIGS. 1-6, may comprise any suitable pattern that is desired to decorate an appliance (e.g., side-by-side refrigerator 10). Such decorative patterns may be applied to the decorative sheets in any conventional method known to one of ordinary skill in the art. In the present invention, the front surfaces (e.g., 21, 31, 41, 51, 61, and 71) may be elastomeric, and the decorative patterns may be adhered to the front surfaces (e.g., 21, 31, etc.) of the decorative sheets by such techniques as silk screening, painting, or other techniques well known to those skilled in the art. Alternatively, a vinyl sheet (not shown) or alternative print sensitive film (not shown) can be laminated to the flexible magnetic elastomeric sheet 10 to define a laminated sheet and facilitate printing, silk screening or other application of the desired decorative pattern/design. The decorative pattern may be applied to the magnetic sheet or to the vinyl overlay in a continuous process by paint or silk screen rollers or a preprinted vinyl sheet can be laminated on the underlying magnetic surface in a continuous process by pressure roller or rollers, further according to the knowledge of those skilled in the art. In an alternative embodiment, the decorative pattern may be applied to a roll of laminate (e.g., multiple layer sheet comprising a vinyl front side and a magnetic back side). Once the decorative pattern is applied to the, varying sizes of the decorative sheet are cut from the laminate. Alternatively, the vinyl side of the sheets may also comprise a paintable or markable surface so that a person can create his own design or to provide a surface for written messages, educational children's games or prints, for example.

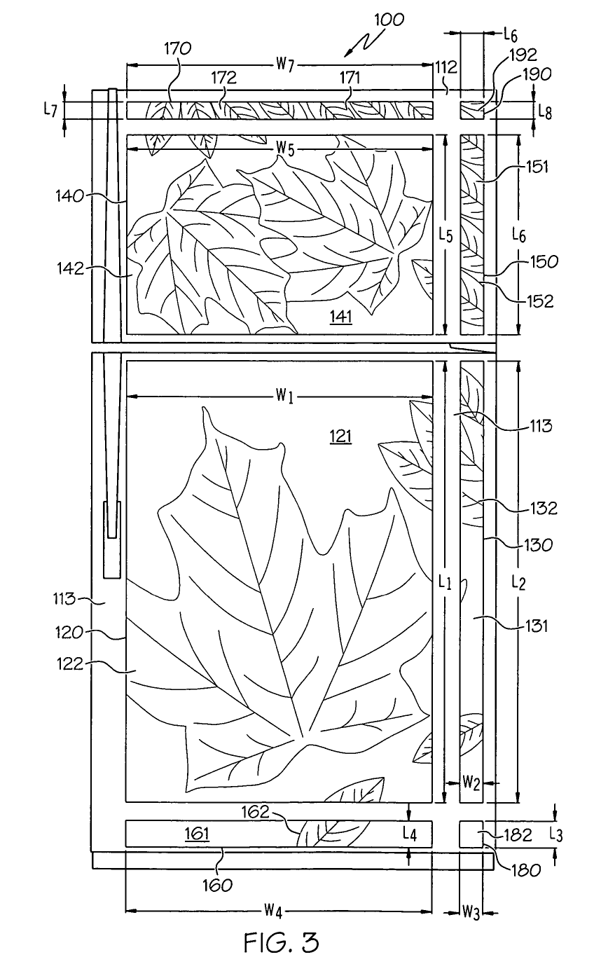

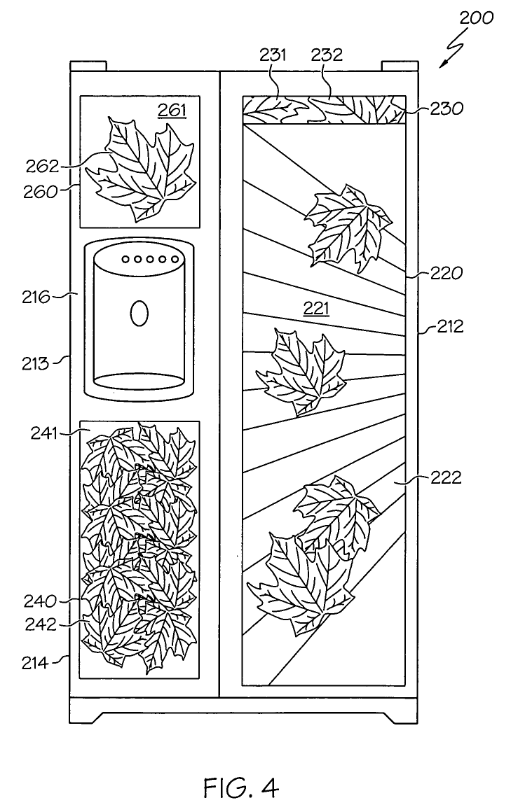

Moreover, decorative pattern 12 may be any suitable pattern such as a floral pattern, picture, pictorial pattern or even a solid pattern, such as a stainless steel-looking pattern, wood-grain, continuous color, or multiple colors or the like. In addition, decorative pattern 12 of each sheet 10 may comprise a different pattern but substantially similar that when place together they form a common or substantially similar decorative theme 11. For example, as shown in FIG. 1, sheets 10a, 10b, and 10c all have different decorative patterns 12a, 12b, and 12c, but each are similar or substantially similar that when all three sheets are applied to refrigerator doors 21 and 22, they provide a decorative patterned theme 11 (e.g., sunflowers). In another example shown in FIG. 3, sheets 10a, 10b, and 10c have decorative patterns 12a, 12b, and 12c that when sheets 10a, 10b, and 10c are applied to doors 21 and 22, decorative patterns 12a, 12b, and 12c form a decorative patterned theme 11 (e.g., fall theme). In still another exemplary embodiment shown in FIG. 3, sheets 10a and 10b have decorative patterns 12a and 12b that when sheets 10a and 10b are applied to doors 26 and 27, decorative patterns 12a, 12b, and 12c form a decorative patterned theme 11 (e.g., fall theme with close up of leaves). In yet still another exemplary embodiment shown in FIG. 4, sheets 10a and 10b have decorative patterns 12a and 12b that when sheets 10a and 10b are applied to doors 26 and 27, decorative patterns 12a and 12b form a decorative patterned theme 11 (e.g., fall theme with mountains). Such multiple decorative sheets configured to cover an appliance and provide the appliance with a common decorative patterned them may be included in a kit or set as well. This set of decorative sheets 10 provides a consumer with multiple, pre-cut sheets that may be applied to an appliance surface to cover a substantial portion of the appliance and provide a common and/or single decorative patterned theme across all the sheets (e.g., 10a, 10b, and 10c) in the set. It is understood that any decorative theme may be applied to the main sheets without departing from the spirit and scope of the present invention. In addition, it is understood that any number of the decorative main sheets may be used without departing from the spirit and scope of the present invention. It is also understood that first side 14 of main decorative sheets 10 may comprise a variety of conventional material as known to one of ordinary skill in the art, including but not limited to elastomeric, polymeric, vinyl, metal (e.g., stainless), wood, or other like materials.

Referring to FIG. 3, another exemplary embodiment of the decorative main sheets and decorative filler sheets are shown covering a substantial portion of a first door 112 and a second door 113 of a top-freezer refrigerator 100. The exemplary embodiment includes a first main sheet 120 covering a substantial portion of door 113 and a second main sheet 140 covering a substantial portion of door 112. First and second main sheets 120 and 140 may be pre-fabricated to a pre-determined size such that the first and second main sheets may cover a substantial portion of the front external surfaces of the bottom and top doors (e.g., door 113 and 112), respectively, of most top-freezer refrigerators (e.g., refrigerator 100). Since refrigerators come in a variety of sizes and designs, pre-fabricated first main sheet 120 and second main sheet 140 may not completely or substantially cover the external front surfaces of the doors (e.g., 112 and 113) of all top-freezer refrigerators (e.g., refrigerator 100). However, first and second main sheets 120 and 140 may cover a substantial portion of a majority of such doors.

First main sheet 120 may include length dimension (L₁), a width dimension (W₁), a front surface or side 121 having a decorative pattern 122, and a back surface or side (not shown). Second main sheet 140 may include length dimension (L₅), a width dimension (W₅), a front surface or side 141 having a decorative pattern 142, and a back surface or side (not shown). As set forth above, first and second main sheets 120 and 140 include back surfaces configured to attach, adhere, connect, and/or apply the main sheets to doors 112 and 113. For example, the back surfaces may define a magnetic sheet/surface or an adhesive that removably and/or permanently attaches main sheets 120 and 140 to the front external surfaces of bottom door 113 and top door 112, respectively. It is understood that the back surfaces may comprise a variety of other technologies and methods to attach, adhere, connect, or apply first and second main sheets 120 and 140 to respective doors 113 and 112 as known to one of ordinary skill.

Since prefabricated main sheets 120 and 140 may not cover all of the front external surface (e.g., doors 112 and 113) of all top-freezer designs (e.g., refrigerator 100), the present invention includes the prefabricated filler sheets. In the exemplary embodiment, the present invention includes a pre-fabricated first filler sheet 130 and a pre-fabricated second filler sheet 160 configured to a pre-determined size such that the filler sheets cover a portion, substantial portion, majority, and/or most of the front external surface (e.g., door 113) remaining exposed or uncovered by first main sheet 120 of most top-freezer designs (e.g., refrigerator 100). In this particular exemplary embodiment, the present invention optionally includes a pre-fabricated fifth filler sheet 180 configured to a predetermined size such that the fifth filler sheet covers a substantial portion of the front external surface of door 113 remaining uncovered by first main sheet 120, first filler sheet 130, and second filler sheet 160. The exemplary embodiment may also include a pre-fabricated third filler sheet 150 and a pre-fabricated fourth filler sheet 170 configured to a pre-determined size such that the filler sheets cover a portion, substantial portion, majority, and/or most of the front external surface (e.g., door 112) remaining exposed or uncovered by second main sheet 140 of most to-freezer designs (e.g., refrigerator 100). In addition, the exemplary embodiment optionally includes a pre-fabricated sixth filler sheet 190 configured to a predetermined size such that the sixth filler sheet covers a substantial portion of the external surface of door 112 that remains uncovered by second main sheet 140, third filler sheet 150, and fourth filler sheet 170.

As shown in FIG. 3, first filler sheet 130 may include a length dimension (L₂), a width dimension (W₂), a front surface or side 131 having a decorative pattern 132, and a back surface or side (not shown). Second filler sheet 160 may include a length dimension (L₄), a width dimension (W₄), a front surface or side 161 having a decorative pattern 162, and a back surface or side (not shown). Fifth filler sheet 180 may include a length dimension (L₃), a width dimension (W₃), a front surface or side having a decorative pattern 182, and a back surface or side (not shown). Covering door 112, third filler sheet 150 may include a length dimension (L₆), a width dimension (W₆), a front surface or side 151 having a decorative pattern 152, and a back surface or side (not shown). Also, fourth filler sheet 170 may include a length dimension (L₇), a width dimension (W₇), a front surface or side 171 having a decorative pattern 172, and a back surface or side (not shown). Sixth filler sheet 190 may include a length dimension (L₈), a width dimension (W₈), a front surface or side having a decorative pattern 192, and a back surface or side (not shown).

With respect to first main sheet 120, length dimension (L₂) of first filler sheet 130 is substantially equal to length dimension (L₁) of first main sheet 120 while width dimension (W₂) of first filler sheet 130 is at least an order of magnitude less than width dimension W₁. In addition, width dimension (W₄) of second filler sheet 160 is substantially equal to width dimension (W₁) of first main sheet 120 while length dimension L₄ of second filler sheet 160 is at least an order of magnitude less than length dimension (L₁) of the first main sheet. Finally, length dimension (L₃) and width dimension (W₃) of fifth filler sheet 180 are both an order of magnitude less than length dimension (L₁) and width dimension (W₁), respectively.

With respect to second main sheet 140, length dimension (L₆) of third filler sheet 150 is substantially equal to length dimension (L₅) of second main sheet 140 while width dimension (W₆) of third filler sheet 150 is at least an order of magnitude less than width dimension (W₅). In addition, width dimension (W₇) of fourth filler sheet 170 is substantially equal to width dimension (W₅) of second main sheet 140 while length dimension (L₇) of fourth filler sheet 170 is at least an order of magnitude less than length dimension (L₅) of the second main sheet. Finally, length dimension (L₈) and width dimension (W₈) of sixth filler sheet 190 are both an order of magnitude less than length dimension (L₅) and width dimension (W₅), respectively.

The back surfaces or sides of each of the respective first, second, third, fourth, fifth, and sixth filler sheets 130, 160, 150, 170, 180, and 190 may be configured to attach, adhere, connect, or apply the filler sheets to the external surfaces of an appliance. For example, the filler sheet back surfaces may define a magnetic sheet or surface that removably attaches the respective filler sheets (130, 160 and 180, and 150, 170, and 190) to the respective bottom and doors 113 and 112. Similar to the main sheets, each filler sheet back surface may also comprise an adhesive layer or sheet (e.g., pressure sensitive adhesive) that attaches the respective filler sheets to the respective doors 112 and 113. It is understood that the back surfaces may comprise a variety of other technologies and methods to attach, adhere, connect, or apply the filler sheets to doors 112 and 113 of refrigerator 100 as known to one of ordinary skill.

As shown in FIG. 3, first filler sheet 130 includes decorative pattern 132 that corresponds to and is an extension of decorative pattern 122, and second filler sheet 160 includes decorative pattern 162 that corresponds to and is an extension of decorative pattern 122. Third filler sheet 150 includes decorative pattern 152 that corresponds to and is an extension of decorative pattern 142, and fourth filler sheet 170 includes decorative pattern 172 that corresponds to and is an extension of decorative patter 142. Although not required by the invention, the decorative pattern of the main sheets and the filler sheets as shown in FIG. 3 all comprise a fall leaf pattern, creating a common or similar decorative theme across all the sheets.

In one exemplary embodiment shown in FIGS. 1 and 2, each of main sheets 10a and 10b is configured to cover at least 51% of the surface area of each of sections 23 and 24 of left door 21, and decorative sheet 10c is configured to cover at least about 51% of right door 25. In another exemplary embodiment, each of main sheets 10a and 10b is configured to cover at least 75% of the surface area of each of sections 23 and 24 of left door 21, and decorative sheet 10c is configured to cover at least about 75% of right door 25. In still another exemplary embodiment, each of main sheets 10a and 10b is configured to cover at least 90% of the surface area of each of sections 23 and 24 of left door 21, and decorative sheet 10c is configured to cover at least about 90% of right door 25.

Referring to FIG. 4, another exemplary embodiment of the present invention is shown as including a first main sheet 220 for covering a portion of a front external surface of a right door 212 of most side-by-side refrigerators (e.g., side-by-side refrigerator 200), a second main sheet 240 for covering a portion of a front external surface of a lower portion 214 of a left door 213 of most side-by-side refrigerators (e.g., refrigerator 200), and a third main sheet 260 for covering a portion of a front external surface of an upper portion 216 of left door 213.

Although not required, in the exemplary embodiment, first main sheet 220 is sized to cover a substantial portion or most of the front external surface of right door 212, and second and third main sheets 240 and 260 are sized to cover a substantial portion or most of the front external surfaces of lower portion 214 and upper portion 216 of left door 213, respectfully, for most side-by-side refrigerator designs. First main sheet 20 may include a front surface or side 221 having a decorative pattern 222, and a back surface or side (not shown). Second main sheet 240 may include a front surface or side 241 having a decorative pattern 242, and a back surface or side (not shown). Third main sheet 260 may include a front surface or side 261 having a decorative pattern 262, and a back surface or side (not shown). As shown in FIG. 4, decorative patterns 222, 242, and 262 correspond to each other (e.g., fall leaf images).

The exemplary embodiment illustrated in FIG. 4 includes one filler sheet 230 that includes a front side 321 having a filler sheet decorative pattern 232 and a back surface (not shown). Decorative pattern 232 corresponds to the decorative patterns of main sheets 222, 242, and 262. Filler sheet 230 is designed and pre-fabricated to cover a portion, substantial portion, majority, and/or most of any remaining portion of the front external surface of door 212 that is left exposed or uncovered by main sheet 220. It is understood that the main sheets and filler sheets may include any and/or all the elements and/or features found in the other exemplary embodiments shown and described herein (e.g., magnetic back surface). It is also understood that the main sheets and the filler sheets of this embodiment may be pre-fabricated.

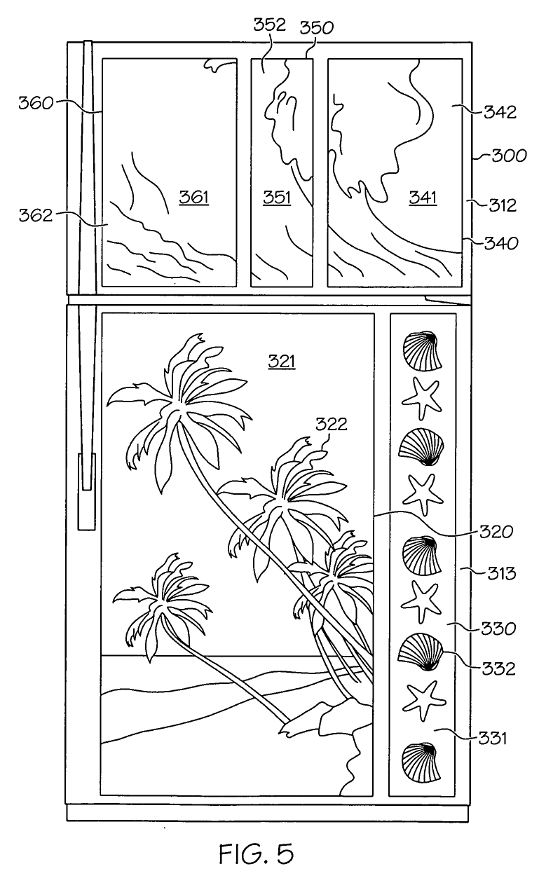

Referring to FIG. 5, another exemplary embodiment of the present invention is shown as including a first main sheet 320 for covering a portion of a front external surface of a bottom door 313 of most top-freezer refrigerators (e.g., refrigerator 300), a second main sheet 340 for covering a portion of a front external surface of a portion of an upper door 312 of most top-freezer refrigerators (e.g., refrigerator 300), and a third main sheet 360 for covering a portion of a front external surface of a portion of door 312 of most top-freezer refrigerators (e.g., refrigerator 300).

Although not required, in the exemplary embodiment, first main sheet 320 is sized to cover a substantial portion or most of the front external surface of door 313, and second and third main sheets 340 and 360 are sized to cover a substantial portion or most of the front external surface of door 312, respectfully. First main sheet 320 may include a front surface or side 321 having a decorative pattern 322, and a back surface or side (not shown). Second main sheet 340 may include a front surface or side 341 having a decorative pattern 342, and a back surface or side (not shown). Third main sheet 360 may include a front surface or side 361 having a decorative pattern 362, and a back surface or side (not shown). As shown in FIG. 5, decorative patterns 322, 342, and 362 correspond to each other (e.g., Ocean/beach images).

The exemplary embodiment illustrated in FIG. 5 includes a first filler sheet 330 that includes a front side 331 having a filler sheet decorative pattern 332 and a back surface (not shown). Decorative pattern 332 corresponds to the decorative patterns of main sheets 322, 342, and 362. First filler sheet 330 is designed and pre-fabricated to cover a portion, substantial portion, majority, and/or most of any remaining portion of the front external surface of door 313 that is left exposed or uncovered by main sheet 320.

The exemplary embodiment also includes a second filler sheet 350 that includes a front side 351 having a filler sheet decorative pattern 352 and a back surface (not shown). Decorative pattern 352 corresponds to the decorative patterns of main sheets 322, 342, and 362. Second filler sheet 350 is designed and pre-fabricated to cover a portion, substantial portion, majority, and/or most of any remaining portion of the front external surface of door 312 that is left exposed or uncovered by main sheet 340 and 360. It is understood that the main sheets and filler sheets may include any and/or all the elements and/or features found in the other exemplary embodiments shown and described herein (e.g., magnetic back surface). It is also understood that the main sheets and the filler sheets of this embodiment may be pre-fabricated.

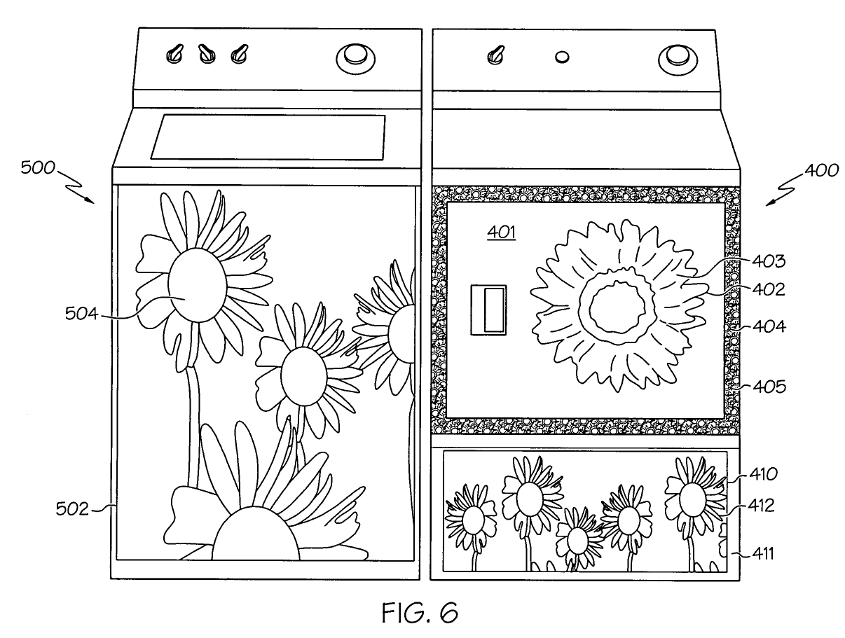

Still another exemplary embodiment of the present invention includes multiple decorative sheets that cover multiple appliances located in one room, wherein the multiple decorative sheets include decorative patterns that correspond with each other in order to create a common or single decorative theme across the appliances as shown in FIG. 6. FIG. 6 illustrates a dryer 400 and a washer 500 that have multiple decorative main sheets attached to their front external surfaces. The exemplary embodiment includes a first main sheet 403 configured to cover a portion of a front external surface of most front-load dryers (e.g., a door 401 of dryer 400), a second main sheet 410 configured to cover a portion of a bottom panel 411 of most front-load dryers (e.g., dryer 400), and a third main sheet 502 configured to cover a portion of most top-load washers (e.g., 500). First main sheet 402, second main sheet 410, and third main sheet 502 include decorative patterns 403, 412, and 504, respectively. In the exemplary embodiment, the decorative patterns all correspond with each other. As shown, the exemplary embodiment of the present invention may include one or more filler sheets (e.g., filler sheet 404) configured to cover a portion of the remaining area of the front surface left exposed by the main sheets. Filler sheet 404 may also include a decorative pattern 405 that also corresponds with the decorative patterns of the main sheets. It is understood that the main sheets and filler sheets may include any and/or all the elements and/or features found in the other exemplary embodiments shown and described herein (e.g., magnetic back surface). It is also understood that the main sheets and the filler sheets of this embodiment may be pre-fabricated.

Having described the invention in detail and by reference to preferred embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed:

1. A plurality of decorative sheeting for changing the appearance of an appliance, comprising:
a first main sheet having a first dimension, a second dimension, and a first surface having a decorative pattern; and
a first filler sheet having a first dimension, a second dimension, a first surface having a filler sheet decorative pattern that corresponds to the decorative pattern of the first main sheet;
wherein the first dimension of the first filler sheet is substantially equal to the first dimension of the first main sheet and the second dimension of the first filler sheet is an order of magnitude less than the second dimension of the first main sheet;
wherein the first main sheet is configured to cover a portion of a first external surface located on a first side of an appliance and the first filler sheet is configured to cover a portion of the first external surface, adjacent to the first main sheet.

2. The plurality of decorative sheeting according to claim 1, further comprising a second main sheet having a first dimension, a second dimension, a first surface having a decorative pattern, wherein the second main sheet is configured to cover a second external surface of the first side of the appliance.

3. The plurality of decorative sheeting according to claim 2, further comprising a second filler sheet having a first dimension, a second dimension, a first surface having a filler sheet decorative pattern that corresponds to the decorative pattern of the second main sheet;
wherein the first dimension of the second filler sheet is substantially equal to the first dimension of the second main sheet and the second dimension of the second filler sheet is an order of magnitude less than the second dimension of the second main sheet;
wherein the second filler sheet is configured to cover a portion of the second external surface, adjacent to the second main sheet.

4. The plurality of decorative sheeting according to claim 3, further comprising a third main sheet having a first dimension, a second dimension, a first surface having a decorative pattern, wherein the third main sheet is configured to cover a portion of a third external surface of the first side of the appliance.

5. The plurality of decorative sheeting according to claim 4, further comprising a third filler sheet having a first dimension, a second dimension, a first surface having a filler sheet decorative pattern that corresponds to the decorative pattern of the third main sheet;
wherein the first dimension of the third filler sheet is substantially equal to the first dimension of the third main sheet and the second dimension of the third filler sheet is an order of magnitude less than the second dimension of the third main sheet;
wherein the third filler sheet is configured to cover a portion of the third external surface, adjacent to the third main sheet.

6. The plurality of decorative sheeting according to claim 3, wherein the decorative pattern of the second main sheet corresponds to the decorative pattern of the first main sheet, creating a common decorative pattern across the first and second main sheets and the first and second filler sheets.

7. The plurality of decorative sheeting according to claim 1, wherein the filler sheet decorative pattern of the first filler sheet completes the decorative pattern of the first main sheet.

8. The plurality of decorative sheeting according to claim 1, wherein the first main sheet and the first filler sheet, each include a second surface configured to attach the first main sheet and the first filler sheet to the first external surface.

9. The plurality of decorative sheeting according to claim 8, wherein the second surfaces of the first main sheet and the first filler sheet comprise a magnetic sheet configured to removably attach the first main sheet and the first filler sheet to the first external surface.

10. The plurality of decorative sheeting according to claim 8, wherein the second surfaces of the first main sheet and the first filler sheet comprise an adhesive configured to attach the first main sheet and the first filler sheet to the first external surface.

11. The plurality of decorative sheeting according to claim 1, wherein the first main sheet and the first filler sheet form a kit.

12. A system for changing the appearance of an appliance having an original appearance, comprising:
first and second main sheets for covering a portion of respective first and second external surfaces located on a first side of an appliance, each of the first and second main sheets having a first dimension, a second dimension, a first surface having a decorative pattern; and
at least one filler sheet for covering a portion of at least one of first and second external surfaces, the at least on filler sheet having a first dimension, a second dimension, a first surface having a filler sheet decorative pattern that corresponds to the decorative pattern of at least one of the first and second main sheets;
wherein the first dimension of the at least one filler sheet is substantially equal to the first dimension of at least one of the first and second main sheets and the second dimension of the at least one filler sheet is an order of magnitude less than the second dimension of at least one of the first and second main sheets.

13. The system according to claim 12, wherein the at least one filler sheet is adapted to substantially cover any remaining portion of the first external surface not covered by the first main sheet.

14. The plurality of decorative sheeting according to claim 13, wherein first and second main sheets are configured to cover a majority of the respective first and second external surfaces.

15. The system according to claim 12, wherein the at least one filler sheet comprises
a first filler sheet for substantially covering any remaining portion of the first external surface not covered by the first main sheet; and
a second filler sheet for substantially covering any remaining portion of the second external surface not covered by the second main sheet;
wherein each of the first and second filler sheets having a first dimension and a second dimension, a first surface having a filler decorative pattern that corresponds to the decorative pattern of the respective first and second main sheets;
wherein the first dimensions of the first and second filler sheets are substantially equal to the first dimensions of the respective first and second main sheets and the second dimensions of the first and second filler sheets are an order of magnitude less than the second dimensions of the respective first and second main sheets.

16. The system according to claim 12, wherein the first dimensions of the first and second main sheets are substantially equal to respective widths of the first and second external surfaces, wherein the first dimension of the at least one filler sheet is equal to the width of at the firs and second external surfaces, and wherein the second dimension of the first main sheet plus the second dimension of the at least one filler sheet are substantially equal to the length of the first external surface.

17. The system according to claim 12, wherein the decorative pattern of the first main sheet corresponds with the decorative pattern of the second main sheet, and wherein the filler sheet decorative pattern of the at least one filler sheet corresponds with the decorative patterns of the first and second mains sheets to form a common decorative pattern across all the sheets.

18. A method for changing the appearance of an appliance having an original appearance, comprising:
providing a first main sheet for covering a portion of a first external surface located on a first side of an appliance, wherein the first main sheet includes a first dimension, a second dimension, a first surface having a decorative pattern, and a second surface for attaching to the first external surface; and
providing a first filler sheet for substantially covering any remaining portion of the first external surface not covered by the first main sheet, wherein the first filler sheet having a first dimension, a second dimension, a first surface of the filler sheet having a filler sheet decorative pattern that corresponds to the decorative pattern of the first main sheet, and a second surface of the filler sheet for attaching to the first external surface;
making the first dimension of the first filler sheet to be substantially equal to the first dimension of the first main sheet; and
making the second dimension of the first filler sheet to be an order of magnitude less than the second dimension of the first main sheet.

19. The method according to claim 18, further comprising:
providing a second main sheet for covering a portion of a second external surface located on the first side of the appliance, wherein the second main sheet includes a first dimension, a second dimension, a first surface having a decorative pattern, and a second surface for adhering to the second external surface; and
providing a second filler sheet for substantially covering any remaining portion of the second external surface not covered by the second main sheet, wherein the second filler sheet having a first dimension, a second dimension, a first surface having a filler sheet decorative pattern that corresponds to the decorative pattern of the second main sheet, and a second side for adhering to the second external surface;
making the first dimension of the second filler sheet to be substantially equal to the first dimension of the second main sheet; and
making the second dimension of the second filler sheet to be an order of magnitude less than the second dimension of the second main sheet.

20. The method according to claim 18, further comprising:
attaching the first main sheet to a first external surface located on a first side of an appliance; and
attaching the first filler sheet to the first external surface, adjacent to the first main sheet.

21. The method according to claim 19, further comprising:
attaching the second main sheet to a second external surface located on a first side of the appliance; and
attaching the second filler sheet to the second external surface, adjacent to the second main sheet.
